(19) United States
(12) Patent Application Publication
(10) Pub. No.: US 2023/0342752 A1
(43) Pub. Date: Oct. 26, 2023

(54) Paddleboard Rental Assembly

(71) Applicant: Diego Gutierrez, New Castle, CO (US)

(72) Inventor: Diego Gutierrez, New Castle, CO (US)

(21) Appl. No.: 17/725,114

(22) Filed: Apr. 20, 2022

(51) Int. Cl. G06Q 20/34; G06Q 30/06; B60P 3/10; B62D 63/08; B60P 7/08

(52) U.S. Cl. CPC G06Q 20/34; G06Q 30/0645; B60P 3/1066; B62D 63/08; B60P 7/08; B60D 1/06

(57) ABSTRACT

A paddleboard rental assembly includes a trailer and a plurality of locking stations that is each coupled to the trailer. Each of the locking stations releasably engages a paddleboard for securing the paddleboard to the trailer. A plurality of lock boxes is each of the lock boxes is attached to the trailer thereby facilitating each of the lock boxes to contain a life preserver. A plurality of pay stations is each attached to the trailer. Each of the pay stations has a card reader to read a financial transaction card for processing a payment. Respective locking stations are unlocked when the pay station associated with the respective locking station processes the payment to facilitate a patron to rent a paddleboard. A respective lock box is unlocked when the pay station associated with the respective lock box processes the payment to facilitate the patron to rent a lifejacket.

### CROSS-REFERENCE TO RELATED APPLICATIONS

Not Applicable

### Statement Regarding Federally Sponsored Research or Development

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### Statement Regarding Prior Disclosures by the Inventor or Joint Inventor

Not Applicable

### BACKGROUND OF THE INVENTION

### (1) Field of the Invention

The disclosure relates to rental devices and more particularly pertains to a new rental device for securely storing a plurality of paddleboards and a plurality of life preservers for rental purposes. The device includes a trailer with a plurality of locking stations which each releasably engages a paddleboard and the device includes a plurality of lock boxes which each stores a life preserver. The device includes a plurality of payment stations for processing a financial transaction card to receive a rental payment. A respective locking station and a respective lock box is unlocked when a rental payment is processed to facilitate a paddleboard and a life preserver to be rented for temporary use.

### (2) Description of Related Art Including Information Disclosed Under 37 CFR 1.97 and 1.98

The prior art relates to rental devices including a board carrying trailer that includes a trailer and a plurality of stanchions, each spaced apart from each other for holding a plurality of boards between respective stanchions. The prior art discloses a rental system to remotely facilitate commercial rental of physical assets at specific locations. The prior art discloses a method of renting a boat comprising a boat positioned on a trailer that is delivered to a renter. The prior art discloses a paddleboard storage tree that has a plurality arms for holding a plurality of paddleboards. The prior art discloses a rental locker assembly that includes a plurality of storage lockers for storing kayaks and paddleboards for renting.

### BRIEF SUMMARY OF THE INVENTION

An embodiment of the disclosure meets the needs presented above by generally comprising a trailer and a plurality of locking stations that is each coupled to the trailer. Each of the locking stations releasably engages a paddleboard for securing the paddleboard to the trailer. A plurality of lock boxes is each of the lock boxes is attached to the trailer thereby facilitating each of the lock boxes to contain a life preserver. A plurality of pay stations is each attached to the trailer. Each of the pay stations has a card reader to read a financial transaction card for processing a payment. Respective locking stations are unlocked when the pay station associated with the respective locking station processes the payment to facilitate a patron to rent a paddleboard. A respective lock box is unlocked when the pay station associated with the respective lock box processes the payment to facilitate the patron to rent a lifejacket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of a paddleboard rental assembly according to an embodiment of the disclosure.

FIG. 2 is a back view of an embodiment of the disclosure.

FIG. 3 is a top view of an embodiment of the disclosure.

FIG. 4 is a detail view taken from circle 4 of FIG. 1 of an embodiment of the disclosure.

FIG. 5 is a schematic view of an embodiment of the disclosure.

### DETAILED DESCRIPTION OF THE INVENTION

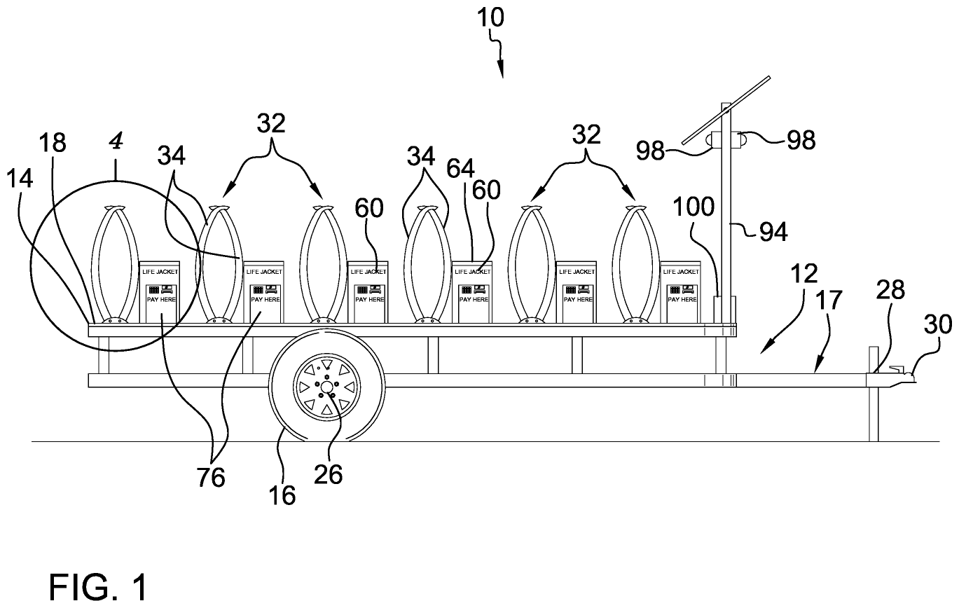

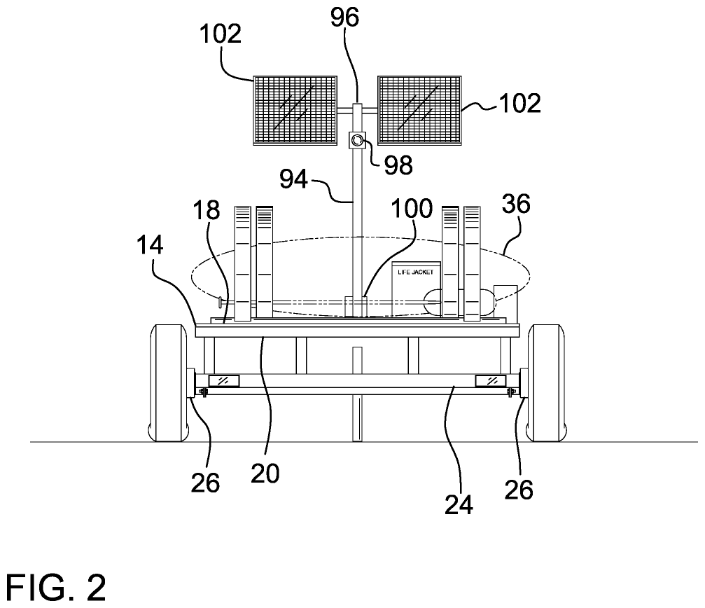

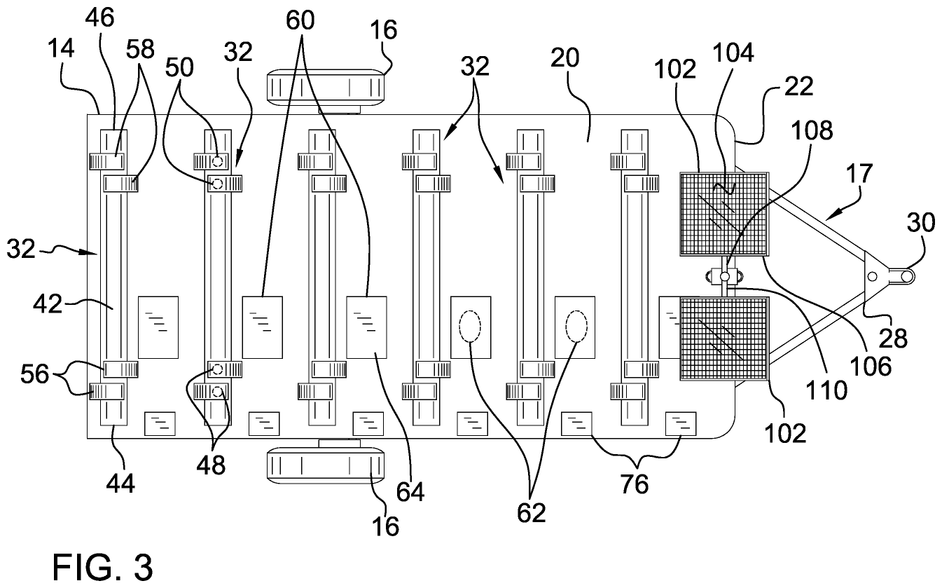

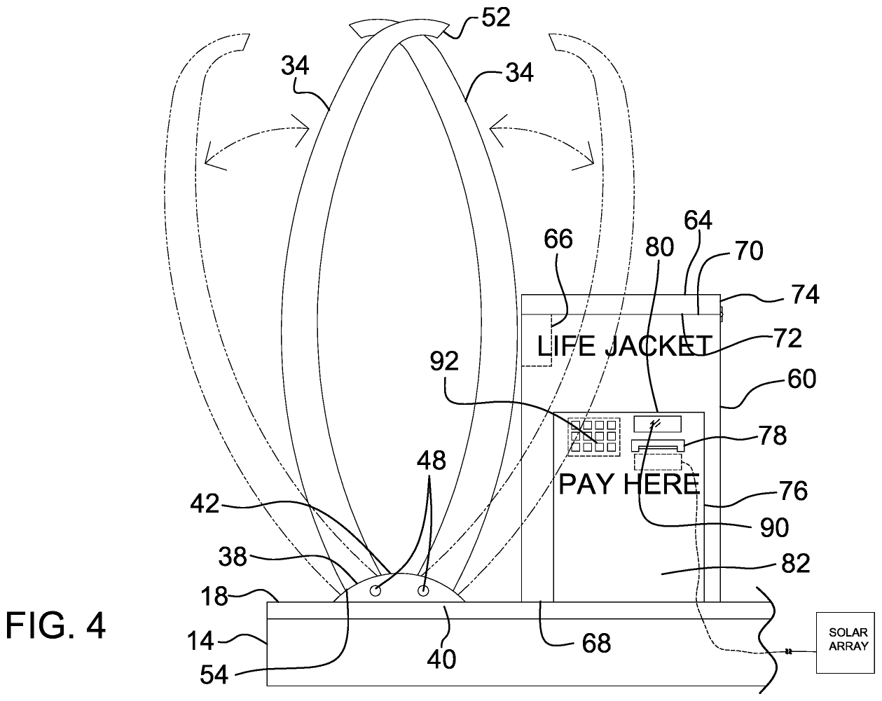

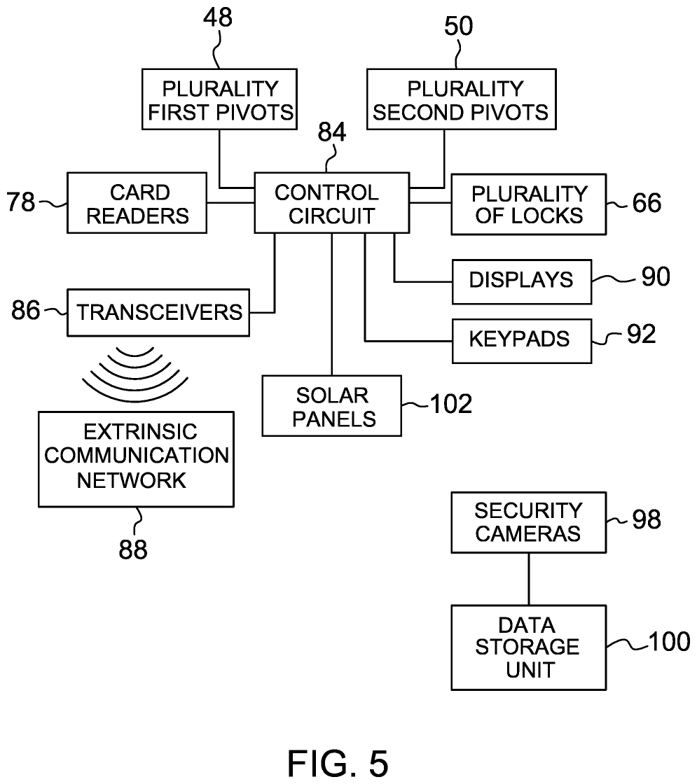

With reference now to the drawings, and in particular to FIGS. 1 through 5 thereof, a new rental device embodying the principles and concepts of an embodiment of the disclosure and generally designated by the reference numeral 10 will be described.

As best illustrated in FIGS. 1 through 5, the paddleboard rental assembly 10 generally comprises a trailer 12 that has a bed 14, a pair wheels 16 rotatably disposed on the bed 14 and a hitch 17 extending forwardly from the bed 14 which can be attached to a vehicle for towing the trailer 12. The bed 14 has a top side 18, a bottom side 20 and a front end 22, and the trailer 12 includes an axle 24 that is attached to the bottom side 20 of the bed 14. The axle 24 extends laterally across the bed 14 and a hub 26 of each of the wheels 16 is rotatably attached to opposing ends of the axle 24 for rolling along a support surface. The hitch 17 extends forwardly from the front end 22 of the bed 14, the hitch 17 has a distal end 28 with respect to the front end 22 and the hitch 17 has a receiver 30 that is disposed on the distal end 28 to engage a ball on a tow hitch 17 of the vehicle.

A plurality of locking stations 32 is provided and each of the locking stations 32 is coupled to the trailer 12. Each of the locking stations 32 has a pair of sets of arms 34 and each of the sets of arms 34 is hingedly disposed on a respective locking station 32. Each of the sets of arms 34 is lockable in a first position having each of the arms 34 extending upwardly from the respective locking station 32 thereby facilitating each of the arms 34 to extend over a paddleboard 36 for securing the paddleboard 36 to the trailer 12. The paddleboard 36 may be a paddleboard of any conventional design that is commonly employed for padding on a body of water. Each of the sets of arms 34 is unlockable into a second position having the sets of arms 34 angling away from each of other thereby facilitating the paddleboard 36 to be removed from the trailer 12.

Each of the locking stations 32 comprises a housing 38 that has a lower side 40 and an upper side 42; the lower side 40 is planar, the upper side 42 is convexly arcuate with the lower side 40 and the lower side 40 is attached to the top side 18 of the bed 14 of the trailer 12. The housing 38 is oriented to extend laterally across the bed 14, the housing 38 has a first end 44 and a second end 46, and the housing 38 is elongated between the first end 44 and the second end 46. Each of the locking stations 32 includes a set of first pivots 48 that is each rotatably integrated into the housing 38. Each of the first pivots 48 is actuatable into a locking condition thereby inhibiting the first pivots 48 from rotating and each of the first pivots 48 is actuatable into an unlocked condition thereby facilitating the first pivots 48 to rotate. Each of the first pivots 48 is positioned adjacent to the first end 44 and each of the first pivots 48 is normally actuated into the locking condition. Each of the first pivots 48 may include an electro-mechanical actuator that facilitates the first pivots 48 to be either locked into place or to be freely movable.

Each of the locking stations 32 includes a set of second pivots 50 that is each rotatably integrated into the housing 38. Each of the second pivots 50 is actuatable into a locking condition thereby inhibiting the second pivots 50 from rotating and each of the second pivots 50 is actuatable into an unlocked condition thereby facilitating the second pivots 50 to rotate. Each of the second pivots 50 is positioned adjacent to the second end 46 and each of the second pivots 50 is normally actuated into the locking condition. Furthermore, each of the second pivots 50 may include an electro-mechanical actuator that facilitates the second pivots 50 to be either locked into place or to be freely movable.

Each of the sets of arms 34 has an upper end 52 and a lower end 54, each of the sets of arms 34 is curved between the upper end 52 and the lower end 54 and each of the sets of arms 34 includes a set of first arms 56 and a set of second arms 58. The lower end 54 of each of the first arms 56 is attached to a respective one of the first pivots 48 and the lower end 54 of each of the second arms 58 is attached to a respective one of the second pivots 50. The upper end 52 of each of the first arms 56 is positioned adjacent to each other having the first arms 56 curving outwardly from each other when the first pivot are 48 in the locking condition. In this way each of the first arms 56 can extend around the paddleboard 36 for securing the paddleboard 36 to the trailer 12.

The upper end 52 of each of the first arms 56 is spaced apart from each other when the first pivot is in the unlocked condition to facilitate the paddleboard 36 to be removed from the trailer 12. The upper end 52 of each of the second arms 58 is positioned adjacent to each other having the second arms 58 curving outwardly from each other when the second pivots 50 are in the locking condition. In this way each of the second arms 58 can extend around the paddleboard 36 for securing the paddleboard 36 to the trailer 12. Conversely, the upper end 52 of each of the second arms 58 is spaced apart from each other when the second pivots 50 are in the unlocked condition to facilitate the paddleboard 36 to be removed from the trailer 12. Each of the first arms 56 and each of the second arms 58 has a length that is less than the maximum width of the paddleboard 36. In this way the paddleboard 36 is inhibited from being removed from the locking station 32 32 without authorization.

A plurality of lock boxes 60 is provided and each of the lock boxes 60 is attached to the trailer 12 thereby facilitating each of the lock boxes 60 to contain a life preserver 62. The life preserver 62 may comprise any personal floatation device that complies with United States Coast Guard safety requirements. Each of the lock boxes 60 has a lid 64 that is hingedly attached to a respective lock box 60 and each of the lock boxes 60 has a lock 66 that is integrated into a respective lock box 60. The lock 66 in a respective lock box 60 engages the lid 64 on the respective lock box 60 when the lock 66 in the respective lock box 60 is actuated for inhibiting the lid 64 on the respective lock box 60 from being opened to secure the life preserver 62 in the respective lock box 60. Conversely, the lock 66 in the respective lock box 60 disengages the lid 64 on the respective lock box 60 when the lock 66 in the respective lock box 60 is de-actuated thereby facilitating the lid 64 on the respective lock box 60 to be opened to removing the life preserver 62 from the respective lock box 60. The lock 66 in each of the lock boxes 60 is normally actuated and the lock 66 in each of the lock boxes 60 may comprise an electromagnet.

Each of the lock boxes 60 has a lowermost end 68 and an uppermost end 70, and the uppermost end 70 of each of the lock boxes 60 is open to access an interior of the lock boxes 60. The lowermost end 68 of each of the lock boxes 60 is attached to the top side 18 of the bed 14 and each of the lock boxes 60 is positioned adjacent to the housing 38 of a respective one of the locking stations 32. The lid 64 associated with each of the lock boxes 60 has a bottom surface 72 and a rear edge 74, and the rear edge 74 of the lid 64 associated with each of the lock boxes 60 is hingedly coupled to the uppermost end 70 of the respective lock box 60. The bottom surface 72 of the lid 64 associated with each of the lock boxes 60 rests on the uppermost end 70 of the respective lock box 60 when the lid 64 is closed. The lid 64 associated with each of the lock boxes 60 may be comprised of a ferromagnetic material thereby facilitating the lid 64 to be magnetically engaged by the lock 66 in the associated lock box 60. Furthermore, the electromagnet of the lock 66 associated with each of the lock boxes 60 may produce a magnetic field of sufficient intensity to inhibit a human being from being able to open the lid 64 when the lock 66 is actuated.

A plurality of pay stations 76 is each attached to the trailer 12 and each of the pay stations 76 has a card reader 78 that is integrated into a respective pay station 76 to read a financial transaction card for processing a payment. Each of the pay stations 76 is in communication with a respective one of the locking stations 32 and a respective one of the lock boxes 60. Furthermore, each of the arms 34 associated with the respective locking station 32 is unlocked into the second position when the pay station 76 associated with the respective locking station 32 processes the payment. In this way the respective locking station 32 can facilitate a patron to rent the paddleboard 36 in the respective locking station 32. The lock 66 in the respective lock box 60 is de-actuated when the pay station 76 associated with the respective lock box 60 processes the payment to facilitate the patron to rent the lifejacket 62 in the respective lock box 60.

Each of the pay stations 76 comprises a tower 80 that is coupled to and extends upwardly from the top side 18 of the bed 14 of the trailer 12. The tower 80 has a front face 82 and the tower 80 is positioned adjacent to a respective one of the lock boxes 60. Each of the pay stations 76 includes a control circuit 84 that is integrated into the tower 80 and the control circuit 84 receives a payment input. The control circuit 84 in each of the pay stations 76 is electrically coupled to each of the first pivots 48 and each of the second pivots 50 associated with a respective one of the locking stations 32 and the control circuit 84 is electrically coupled to the lock 66 of a respective one of the lock boxes 60. Each of the first pivots 48 and the second pivots 50 is actuated into the unlocked condition when the control circuit 84 receives the payment input and the lock 66 in the respective lock box 60 is de-actuated when the control circuit 84 receives the payment input.

The card reader 78 associated with each of the lock boxes 60 is attached to the front face 82 of the tower 80 and the card reader 78 is electrically coupled to the control circuit 84. The control circuit 84 receives the payment input when the card reader 78 processes the payment. Each of the pay stations 76 includes a transceiver 86 that is integrated into the tower 80 and the transceiver 86 is electrically coupled to the control circuit 84. The transceiver 86 is in wireless communication with an extrinsic communication network 88 thereby facilitating the transceiver 86 to communicate with a financial institution thereby facilitating the card reader 78 to process the payment. The transceiver 86 may comprise a radio frequency transceiver or the like and the extrinsic communication network 88 may comprise a cellular phone network, the internet or any other type of wireless communication network. Furthermore, the transceiver 86 may employ communication protocols that apply to the specific type of communication network with which the transceiver 86 is communicating.

Each of the pay stations 76 includes a display 90 is coupled to the front face 82 of the tower 80 and the display 90 is electrically coupled to the control circuit 84. The display 90 displays indicia comprising letters and words for communicating information to the patron. Furthermore, the display 90 may comprise a liquid crystal display or other type of electronic display 90. Each of the pay stations 76 includes a keypad 92 that is coupled to the front face 82 of the tower 80 and the keypad 92 is electrically coupled to the control circuit 84 thereby facilitating the keypad 92 to be manipulated by the patron for entering a pin number for the financial transaction card and other information pertaining to paying for renting a paddleboard 36 and a life preserver 62.

A stanchion 94 is coupled to and extends upwardly from the top side 18 of the bed 14 of the trailer 12 and the stanchion 94 has a distal end 96 with respect to the top side 18. A plurality of security cameras 98 is provided and each of the security cameras 98 is disposed on the trailer 12 thereby facilitating each of the security cameras 98 to record footage of the trailer 12. Each of the security cameras 98 faces in a unique direction with respect to each other and each of the security cameras 98 is positioned on the stanchion 94 at a point that is located proximate the distal end 96 of the stanchion 94. Furthermore, each of the security cameras 98 is electrically coupled to a data storage unit 100 thereby facilitating the data storage unit 100 to store footage recorded by the security cameras 98 to facilitate the footage to be subsequently analyzed. Each of the security cameras 98 may comprise a digital video camera or the like and the data storage unit 100 may comprise a digital data storage unit for storing digital imagery recorded by the security cameras 98.

A plurality of solar panels 102 is provided and each of the solar panels 102 has an upper surface 104 and a perimeter edge 106. The perimeter edge 106 of each of the solar panels 102 pivotally engages a respective end 108 of a cross member 110 that is transversely oriented with the stanchion 94. In this way the upper surface 104 of each of the solar panels 102 can be oriented in a preferred direction such that the upper surface 104 of each of the solar panels 102 can be exposed to sunlight. The control circuit 84 in the tower 80 associated with each of the pay stations 76 is electrically coupled to the solar panels 102 and each of the security cameras 98 is electrically coupled to the solar panels 102.

In use, the trailer 12 is towed to a desired location by the owner of the trailer 12 to facilitate the paddleboard 36 and the life preserver 62 to be rented by a patron. A patron approaches a respective one of the pay stations 76 and the patron swipes their financial transaction card through a card reader 78 on the respective pay station 76. The sets of arms 34 on the locking station 32 that is associated with the respective pay station 76 are unlocked into the second position to facilitate the paddleboard 36 to be removed from the locking station 32. Additionally, the lock 66 in the lock box 60 associated with the respective pay station 76 disengages the lid 64 on the lock box 60 associated with the respective pay station 76 to facilitate the life preserver 62 to be removed from the lock box 60 associated with the respective pay station 76. In this way the patron can rent the paddleboard 36 and the life preserver 62 for a pre-determined duration of time. The patron returns the paddleboard 36 to the respective locking station 32, the patron urges each of the sets of arms 34 into the first position to secure the paddleboard 36 to the locking station 32 and the patron returns the life preserver 62 to the respective lock box 60 when the rental period has expired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A paddleboard rental assembly for facilitating the portable renting of paddleboards and lifejackets, said assembly comprising:
a trailer having a bed, a pair wheels being rotatably disposed on said bed and a hitch extending forwardly from said bed wherein said hitch is configured to be attached to a vehicle for towing said trailer;
a plurality of locking stations, each of said locking stations being coupled to said trailer, each of said locking stations having a pair of sets of arms, each of said sets of arms being hingedly disposed on a respective locking station, each of said sets of arms being lockable in a first position having each of said arms extending upwardly from said respective locking station and thereby facilitating each of said arms to extend over a paddleboard for securing the paddleboard to said trailer, each of said sets of arms being unlockable into a second position having said sets of arms angling away from each of other thereby facilitating the paddleboard to be removed from said trailer;
a plurality of lock boxes, each of said lock boxes being attached to said trailer thereby facilitating each of said lock boxes to contain a life preserver, each of said lock boxes having a lid being hingedly attached to a respective lock box, each of said lock boxes having a lock being integrated into a respective lock box, said lock in a respective lock box engaging said lid on said respective lock box when said lock in said respective lock box is actuated for inhibiting said lid on said respective lock box from being opened thereby securing the life preserver in said respective lock box, said lock in said respective lock box disengaging said lid on said respective lock box when said lock in said respective lock box is de-actuated thereby facilitating said lid on said respective lock box to be opened to removing the life preserver from said respective lock box; and
a plurality of pay stations, each of said pay stations being attached to said trailer, each of said pay stations having a card reader being integrated into a respective pay station wherein said card reader in each of said pay stations is configured to read a financial transaction card for processing a payment, each of said pay stations being in communication with a respective one of said locking stations and a respective one of said lock boxes, each of said arms associated with said respective locking station being unlocked into said second position when said pay station associated with said respective locking station processes the payment wherein said respective locking station is configured to facilitate a patron to rent the paddleboard in said respective locking station, said lock in said respective lock box being de-actuated when said pay station associated with said respective lock box processes the payment wherein said respective lock box is configured to facilitate the patron to rent the lifejacket in said respective lock box.

2. The assembly according to claim 1, wherein said bed has a top side, a bottom side and a front end, said trailer including an axle being attached to said bottom side of said bed, said axle extending laterally across said bed, a hub of each of said wheels being rotatably attached to opposing ends of said axle for rolling along a support surface, said hitch extending forwardly from said front end of said bed, said hitch having a distal end with respect to said front end, said hitch having a receiver being disposed on said distal end wherein said receiver is configured to engage a ball on a tow hitch of the vehicle.

3. The assembly according to claim 2, wherein each of said locking stations comprises:
a housing having a lower side and an upper side, said lower side being planar, said upper side being convexly arcuate with said lower side, said lower side being attached to said top side of said bed of said trailer, said housing being oriented to extend laterally across said bed, said housing having a first end and a second end, said housing being elongated between said first end and said second end;
a set of first pivots, each of said first pivots being rotatably integrated into said housing, each of said first pivots being actuatable into a locking condition thereby inhibiting said first pivots from rotating, each of said first pivots being actuatable into an unlocked condition thereby facilitating said first pivots to rotate, each of said first pivots being positioned adjacent to said first end, each of said first pivots being normally actuated into said locking condition; and
a set of second pivots, each of said second pivots being rotatably integrated into said housing, each of said second pivots being actuatable into a locking condition thereby inhibiting said second pivots from rotating, each of said second pivots being actuatable into an unlocked condition thereby facilitating said second pivots to rotate, each of said second pivots being positioned adjacent to said second end, each of said second pivots being normally actuated into said locking condition.

4. The assembly according to claim 3, wherein:
each of said sets of arms has an upper end and a lower end, each of said sets of arms being curved between said upper end and said lower end, each of said sets of arms including a set of first arms and a set of second arms;
said lower end of each of said first arms is attached to a respective one of said first pivots, said lower end of each of said second arms being attached to a respective one of said second pivots, said upper end of each of said first arms being positioned adjacent to each other having said first arms curving outwardly from each other when said first pivot is in said locking condition thereby facilitating each of said first arms to extend around the paddleboard for securing the paddleboard to said trailer, said upper end of each of said first arms being spaced apart from each other when said first pivot is in said unlocked condition to facilitate the paddleboard to be removed from said trailer; and
said upper end of each of said second arms is positioned adjacent to each other having said second arms curving outwardly from each other when said second pivot is in said locking condition thereby facilitating each of said second arms to extend around the paddleboard for securing the paddleboard to said trailer, said upper end of each of said second arms being spaced apart from each other when said second pivot is in said unlocked condition to facilitate the paddleboard to be removed from said trailer.

5. The assembly according to claim 2, wherein:
said lock in each of said lock boxes is normally actuated;
each of said lock boxes having a lowermost end and an uppermost end, said uppermost end of each of said lock boxes being open to access an interior of said lock boxes, said lowermost end of each of said lock boxes being attached to said top side of said bed, each of said lock boxes being positioned adjacent to said housing of a respective one of said locking stations; and
said lid associated with each of said lock boxes has a bottom surface and a rear edge, said rear edge of said lid associated with each of said lock boxes being hingedly coupled to said uppermost end of said respective lock box, said bottom surface of said lid associated with each of said lock boxes resting on said uppermost end of said respective lock box when said lid is closed.

6. The assembly according to claim 3, wherein:
each of said lock boxes includes a lock; and
each of said pay stations comprises:
a tower being coupled to and extending upwardly from said top side of said bed of said trailer, said tower having a front face, said tower being positioned adjacent to a respective one of said lock boxes;
a control circuit being integrated into said tower, said control circuit being electrically coupled to each of said first pivots and each of said second pivots associated with a respective one of said locking stations, said control circuit being electrically coupled to said lock of a respective one of said lock boxes, said control circuit receiving a payment input, each of said first pivots and said second pivots being actuated into said unlocked condition when said control circuit receives said payment input, said lock in said respective lock box being de-actuated when said control circuit receives said payment input.

7. The assembly according to claim 6, wherein:
said card reader associated with each of said lock boxes is attached to said front face of said tower, said card reader being electrically coupled to said control circuit, said control circuit receiving said payment input when said card reader processes the payment; and
each of said pay stations includes a transceiver being integrated into said tower, said transceiver being electrically coupled to said control circuit, said transceiver being in wireless communication with an extrinsic communication network thereby facilitating said transceiver to communicate with a financial institution thereby facilitating said card reader to process the payment.

8. The assembly according to claim 6, wherein each of said pay stations includes:
a display being coupled to said front face of said tower, said display being electrically coupled to said control circuit, said display displaying indicia comprising letters and words for communication information to the patron; and
a keypad being coupled to said front face of said tower, said keypad being electrically coupled to said control circuit thereby facilitating said keypad to be manipulated by the patron for entering a pin number for the financial transaction card and other information pertaining to paying for renting a paddleboard and a life preserver.

9. The assembly according to claim 2, further comprising:
a stanchion being coupled to and extending upwardly from said top side of said bed of said trailer, said stanchion having a distal end with respect to said top side; and
a plurality of security cameras, each of said security cameras being disposed on said trailer thereby facilitating each of said security cameras to record footage of said trailer, each of said security cameras facing in a unique direction with respect to each other, each of said security cameras being positioned on said stanchion at a point being located proximate said distal end of said stanchion, each of said security cameras being electrically coupled to a data storage unit thereby facilitating said data storage unit to store footage recorded by said storage cameras wherein said data storage unit is configured to facilitate the footage to be subsequently analyzed.

10. The assembly according to claim 6, further comprising:
a stanchion being coupled to and extending upwardly from said top side of said bed of said trailer, said stanchion having a distal end with respect to said top side; and
a plurality of solar panels, each of said solar panels having an upper surface and a perimeter edge, said perimeter edge of each of said solar panels pivotally engaging a respective end of a cross member being transversely oriented with said stanchion thereby facilitating said upper surface of each of said solar panels to be oriented in a preferred direction wherein said upper surface of each of said solar panels is configured to be exposed to sunlight, said control circuit in said tower associated with each of said pay stations being electrically coupled to said solar panels.

11. A paddleboard rental assembly for facilitating the portable renting of paddleboards and lifejackets, said assembly comprising:
a trailer having a bed, a pair wheels being rotatably disposed on said bed and a hitch extending forwardly from said bed wherein said hitch is configured to be attached to a vehicle for towing said trailer, said bed having a top side, a bottom side and a front end, said trailer including an axle being attached to said bottom side of said bed, said axle extending laterally across said bed, a hub of each of said wheels being rotatably attached to opposing ends of said axle for rolling along a support surface, said hitch extending forwardly from said front end of said bed, said hitch having a distal end with respect to said front end, said hitch having a receiver being disposed on said distal end wherein said receiver is configured to engage a ball on a tow hitch of the vehicle;
a plurality of locking stations, each of said locking stations being coupled to said trailer, each of said locking stations having a pair of sets of arms, each of said sets of arms being hingedly disposed on a respective locking station, each of said sets of arms being lockable in a first position having each of said arms extending upwardly from said respective locking station and thereby facilitating each of said arms to extend over a paddleboard for securing the paddleboard to said trailer, each of said sets of arms being unlockable into a second position having said sets of arms angling away from each of other thereby facilitating the paddleboard to be removed from said trailer, each of said locking stations comprising:
a housing having a lower side and an upper side, said lower side being planar, said upper side being convexly arcuate with said lower side, said lower side being attached to said top side of said bed of said trailer, said housing being oriented to extend laterally across said bed, said housing having a first end and a second end, said housing being elongated between said first end and said second end;
a set of first pivots, each of said first pivots being rotatably integrated into said housing, each of said first pivots being actuatable into a locking condition thereby inhibiting said first pivots from rotating, each of said first pivots being actuatable into an unlocked condition thereby facilitating said first pivots to rotate, each of said first pivots being positioned adjacent to said first end, each of said first pivots being normally actuated into said locking condition;
a set of second pivots, each of said second pivots being rotatably integrated into said housing, each of said second pivots being actuatable into a locking condition thereby inhibiting said second pivots from rotating, each of said second pivots being actuatable into an unlocked condition thereby facilitating said second pivots to rotate, each of said second pivots being positioned adjacent to said second end, each of said second pivots being normally actuated into said locking condition; and
wherein each of said sets of arms has an upper end and a lower end, each of said sets of arms being curved between said upper end and said lower end, each of said sets of arms including a set of first arms and a set of second arms, said lower end of each of said first arms being attached to a respective one of said first pivots, said lower end of each of said second arms being attached to a respective one of said second pivots, said upper end of each of said first arms being positioned adjacent to each other having said first arms curving outwardly from each other when said first pivot is in said locking condition thereby facilitating each of said first arms to extend around the paddleboard for securing the paddleboard to said trailer, said upper end of each of said first arms being spaced apart from each other when said first pivot is in said unlocked condition to facilitate the paddleboard to be removed from said trailer, said upper end of each of said second arms being positioned adjacent to each other having said second arms curving outwardly from each other when said second pivot is in said locking condition thereby facilitating each of said second arms to extend around the paddleboard for securing the paddleboard to said trailer, said upper end of each of said second arms being spaced apart from each other when said second pivot is in said unlocked condition to facilitate the paddleboard to be removed from said trailer;
a plurality of lock boxes, each of said lock boxes being attached to said trailer thereby facilitating each of said lock boxes to contain a life preserver, each of said lock boxes having a lid being hingedly attached to a respective lock box, each of said lock boxes having a lock being integrated into a respective lock box, said lock in a respective lock box engaging said lid on said respective lock box when said lock in said respective lock box is actuated for inhibiting said lid on said respective lock box from being opened thereby securing the life preserver in said respective lock box, said lock in said respective lock box disengaging said lid on said respective lock box when said lock in said respective lock box is de-actuated thereby facilitating said lid on said respective lock box to be opened to removing the life preserver from said respective lock box, said lock in each of said lock boxes being normally actuated, each of said lock boxes having a lowermost end and an uppermost end, said uppermost end of each of said lock boxes being open to access an interior of said lock boxes, said lowermost end of each of said lock boxes being attached to said top side of said bed, each of said lock boxes being positioned adjacent to said housing of a respective one of said locking stations, said lid associated with each of said lock boxes having a bottom surface and a rear edge, said rear edge of said lid associated with each of said lock boxes being hingedly coupled to said uppermost end of said respective lock box, said bottom surface of said lid associated with each of said lock boxes resting on said uppermost end of said respective lock box when said lid is closed;
a plurality of pay stations, each of said pay stations being attached to said trailer, each of said pay stations having a card reader being integrated into a respective pay station wherein said card reader in each of said pay stations is configured to read a financial transaction card for processing a payment, each of said pay stations being in communication with a respective one of said locking stations and a respective one of said lock boxes, each of said arms associated with said respective locking station being unlocked into said second position when said pay station associated with said respective locking station processes the payment wherein said respective locking station is configured to facilitate a patron to rent the paddleboard in said respective locking station, said lock in said respective lock box being de-actuated when said pay station associated with said respective lock box processes the payment wherein said respective lock box is configured to facilitate the patron to rent the lifejacket in said respective lock box, each of said pay stations comprising:
a tower being coupled to and extending upwardly from said top side of said bed of said trailer, said tower having a front face, said tower being positioned adjacent to a respective one of said lock boxes;
a control circuit being integrated into said tower, said control circuit being electrically coupled to each of said first pivots and each of said second pivots associated with a respective one of said locking stations, said control circuit being electrically coupled to said lock of a respective one of said lock boxes, said control circuit receiving a payment input, each of said first pivots and said second pivots being actuated into said unlocked condition when said control circuit receives said payment input, said lock in said respective lock box being de-actuated when said control circuit receives said payment input;
wherein said card reader associated with each of said lock boxes is attached to said front face of said tower, said card reader being electrically coupled to said control circuit, said control circuit receiving said payment input when said card reader processes the payment;
a transceiver being integrated into said tower, said transceiver being electrically coupled to said control circuit, said transceiver being in wireless communication with an extrinsic communication network thereby facilitating said transceiver to communicate with a financial institution thereby facilitating said card reader to process the payment;
a display being coupled to said front face of said tower, said display being electrically coupled to said control circuit, said display displaying indicia comprising letters and words for communication information to the patron; and
a keypad being coupled to said front face of said tower, said keypad being electrically coupled to said control circuit thereby facilitating said keypad to be manipulated by the patron for entering a pin number for the financial transaction card and other information pertaining to paying for renting a paddleboard and a life preserver;
a stanchion being coupled to and extending upwardly from said top side of said bed of said trailer, said stanchion having a distal end with respect to said top side;
a plurality of security cameras, each of said security cameras being disposed on said trailer thereby facilitating each of said security cameras to record footage of said trailer, each of said security cameras facing in a unique direction with respect to each other, each of said security cameras being positioned on said stanchion at a point being located proximate said distal end of said stanchion, each of said security cameras being electrically coupled to a data storage unit thereby facilitating said data storage unit to store footage recorded by said storage cameras wherein said data storage unit is configured to facilitate the footage to be subsequently analyzed; and
a plurality of solar panels, each of said solar panels having an upper surface and a perimeter edge, said perimeter edge of each of said solar panels pivotally engaging a respective end of a cross member being transversely oriented with said stanchion thereby facilitating said upper surface of each of said solar panels to be oriented in a preferred direction wherein said upper surface of each of said solar panels is configured to be exposed to sunlight, said control circuit in said tower associated with each of said pay stations being electrically coupled to said solar panels, each of said security cameras being electrically coupled to said solar panels.
